(19) United States
(12) Patent Application Publication
(10) Pub. No.: US 2026/0175454 A1
(43) Pub. Date: Jun. 25, 2026

(54) ATTACHMENT SYSTEM FOR MOBILE ROBOTS

(71) Applicant: DUBAI FUTURE FOUNDATION, DUBAI (AE)

(72) Inventors: TANZIM AHMED, DUBAI (AE); JULIAN FERLING, DUBAI (AE); MOHAMMAD ALHAREB, DUBAI (AE); TAREK TAHA, DUBAI (AE); KHALIFA ALQAMA, DUBAE (AE)

(73) Assignee: DUBAI FUTURE FOUNDATION, DUBAI (AE)

(21) Appl. No.: 19/426,309

(22) Filed: Dec. 19, 2025

Related U.S. Application Data
(60) Provisional application No. 63/737,051, filed on Dec. 20, 2024.

(51) Int. Cl. B25J 19/02; B25J 9/00

(52) U.S. Cl. CPC B25J 19/02; B25J 9/0009

(57) ABSTRACT

An attachment system for a mobile robot is disclosed. The attachment system comprises a docking unit configured to be coupled to the mobile robot and to interface with a coupling unit of an attachment to be installed on the mobile robot. The docking unit comprises: an attachment plate comprising one or more attachment ports for respectively interfacing with a corresponding attachment connection of the attachment; and a locking mechanism coupled to the attachment plate and comprising one or more locking units, wherein each of the one or more locking units is configured to receive and engage with a corresponding locking pin of the coupling unit. A mobile robot comprising the attachment system, and a method of configuring a mobile robot, are also disclosed.

### CROSS-REFERENCE TO RELATED APPLICATIONS

This application claims priority to and the benefit of U.S. Provisional Patent Application No. 63/737,051, filed on Dec. 20, 2024, the entire contents of which is hereby incorporated by reference herein for all purposes.

### TECHNICAL FIELD

The present disclosure relates to an attachment system for mobile robots, and in particular to a generalized attachment docking mechanism for Collaborative Mobile Robots (CMRs).

### BACKGROUND

Collaborative Mobile Robots (CMRs) are increasingly being used across industries due to their ability to work alongside human operators. The growth of Autonomous Mobile Robots (AMRs) has revolutionized sectors like warehousing, manufacturing, and material handling by offering flexible, scalable solutions that are much more efficient than traditional systems. However, while CMRs have become essential to these operations, their current attachment systems limit their full potential.

Most existing robotic attachment systems are bespoke-custom-built for specific tasks. While this can optimize performance for that one task, it presents a significant problem when robots need to switch between tasks. Reconfiguring a robot's attachments often involves a labour-intensive process, requiring manual adjustments and even physical modifications to the robot. This drastically reduces efficiency and increases downtime, especially in environments that require quick task transitions.

There is a need for a modular and universal attachment system-one that would allow CMRs to be quickly reconfigured for various tasks without the need for complicated or lengthy adjustments. A universal docking mechanism that could handle multiple task-specific modules would not only enhance operational flexibility but also reduce costs, improve productivity, and create safer working environments by enabling robots to perform a diverse range of tasks.

Accordingly, an additional, alternative, and/or improved attachment system for mobile robots remains highly desirable.

### SUMMARY

In accordance with one aspect of the present disclosure, an attachment system for a mobile robot is disclosed, comprising: a docking unit configured to be coupled to the mobile robot and to interface with a coupling unit of an attachment to be installed on the mobile robot, the docking unit comprising: an attachment plate comprising one or more attachment ports for respectively interfacing with a corresponding attachment connection of the attachment; and a locking mechanism coupled to the attachment plate and comprising one or more locking units, wherein each of the one or more locking units is configured to receive and engage with a corresponding locking pin of the coupling unit.

In some aspects, the attachment plate comprises one or more retention slots each configured to receive the corresponding locking pin of the coupling unit, and wherein the one or more locking units are respectively arranged beneath the one or more retention slots.

In some aspects, each of the one or more locking units comprise a pair of locking arms pivotably coupled at first ends thereof, and coupled via a locking spring at second ends thereof.

In some aspects, the pair of locking arms and the locking pin are sized so that the locking arms are pivoted radially outwards as the locking pin is inserted therein, and the locking pin is shaped so that once inserted in the locking unit, the pair of locking arms are pivoted radially inward to clamp against the locking pin under force of the locking spring.

In some aspects, each locking unit further comprises a slider coupled to the second ends of the pair of locking arms, wherein the slider is configured to cause the pair of locking arms to pivot when actuated.

In some aspects, each locking arm comprises a locking arm pin at the second ends thereof, and wherein the slider comprises a pair of grooves respectively retaining a corresponding locking arm pin.

In some aspects, the pair of grooves are shaped to cause the pair of locking arms to pivot radially outwardly when the slider is actuated away from the locking unit.

In some aspects, the locking mechanism further comprises: a locking plate coupled to the slider of the one or more locking units; and a release lever coupled to the locking plate and configured to be manually actuated, wherein actuation of the release lever is configured to cause a corresponding movement of the locking plate and the slider of the one or more locking units to disengage the locking arms.

In some aspects, the attachment system further comprises the coupling unit configured to be installed on the attachment.

In some aspects, the attachment is a tool, a sensor, or a module.

In accordance with another aspect of the present disclosure, a mobile robot is disclosed, comprising the attachment system of any one of the above aspects.

In some aspects, the attachment is installed on the mobile robot, and the attachment system further comprises the coupling unit coupled to the attachment, the coupling unit is coupled to the docking unit, and the coupling unit comprising one or more locking pins inserted into corresponding of the one or more locking units of the docking unit.

In accordance with another aspect of the present disclosure, a method of configuring a mobile robot is disclosed, comprising: installing a docking unit of an attachment system onto the mobile robot, the docking unit comprising: an attachment plate comprising one or more attachment ports for respectively interfacing with a corresponding attachment connection of an attachment to be installed on the mobile robot; and a locking mechanism coupled to the attachment plate and comprising one or more locking units, wherein each of the one or more locking units is configured to receive and engage with a corresponding locking pin of the coupling unit; installing a coupling unit of the attachment system onto the attachment, the coupling unit comprising one or more locking pins for insertion into corresponding of the one or more locking units of the docking unit; and installing the coupling unit with the attachment onto the docking unit of the mobile robot, wherein the one or more locking pins of the coupling unit are inserted into the one or more locking units of the docking unit.

In some aspects, the method further comprises changing the attachment by: removing the attachment from the mobile robot by disengaging the coupling unit from the docking unit; and installing a new attachment onto the mobile robot by installing the new attachment with a coupling unit thereon to the docking unit installed on the mobile robot.

### BRIEF DESCRIPTION OF THE DRAWINGS

Further features and advantages of the present disclosure will become apparent from the following detailed description, taken in combination with the appended drawings, in which:

FIGS. 1A and 1B show top and bottom perspective views respectively of a docking unit of an attachment system in accordance with the present disclosure;

FIG. 2 shows a representation of a mobile base robot that the attachment system may be used with;

FIG. 3 shows an exploded perspective view of a docking unit of the attachment system;

FIG. 4 shows an enlarged view of a locking unit of the locking mechanism;

FIG. 5 shows perspective and top views of the locking unit operation;

FIG. 6 shows representations of the locking units during engagement and disengagement;

FIGS. 7A and 7B show representations of a release lever mechanism of the locking mechanism;

FIG. 8 shows a representation of the attachment system integrated with the mobile base robot;

FIG. 9 shows representations of a coupling unit integrated with various attachments; and

FIG. 10 shows representations of various attachments coupled with the mobile robot using the attachment system.

It will be noted that throughout the appended drawings, like features are identified by like reference numerals.

### DETAILED DESCRIPTION

The present disclosure provides a generalized and universal attachment system for mobile robots that allows robots to switch attachments easily and securely, enhancing their utility across different industries. With this mechanism in place, robots can be reconfigured and transition to different tasks, such as from transporting goods to assembling components or even conducting inspections, all with minimal downtime.

At its core, the generalized attachment system is a modular attachment system designed to significantly enhance the flexibility and efficiency of Collaborative Mobile Robots (CMRs). The attachment system provides a standardized interface that enables the robot to integrate seamlessly with various attachments. Whether the attachment is a tool, sensor, or additional module, the attachment system allows it to be securely locked into place, ensuring stable and reliable operations in any environment.

This modular attachment system is not just about flexibility—it also provides operational efficiency and future-proofing. The ability to quickly switch attachments means that robots can be deployed in more diverse roles. They can adapt to changing workflows on the fly, reducing the need for multiple specialized robots and cutting costs for businesses. For example, a robot equipped with this attachment system could start the day by carrying out routine inspections, then switch to transporting goods, and later use a precision tool for assembly-all with minimal interruption. This enhanced operational flexibility means that robots are more valuable assets, capable of performing a broader range of tasks, ultimately maximizing their utility and value in any industrial or commercial setting.

By enabling quick reconfiguration through a universal attachment system, the attachment system helps robots become more versatile and cost-effective, making them indispensable in industries that require continuous operation and adaptability.

In at least some embodiments of the present disclosure, the attachment system for a mobile robot comprises a docking unit configured to be coupled to the mobile robot and to interface with a coupling unit of an attachment to be installed on the mobile robot. The docking unit comprises: an attachment plate comprising one or more attachment ports for respectively interfacing with a corresponding attachment connection of the attachment; and a locking mechanism coupled to the attachment plate and comprising one or more locking units, wherein each of the one or more locking units is configured to receive and engage with a corresponding locking pin of the coupling unit.

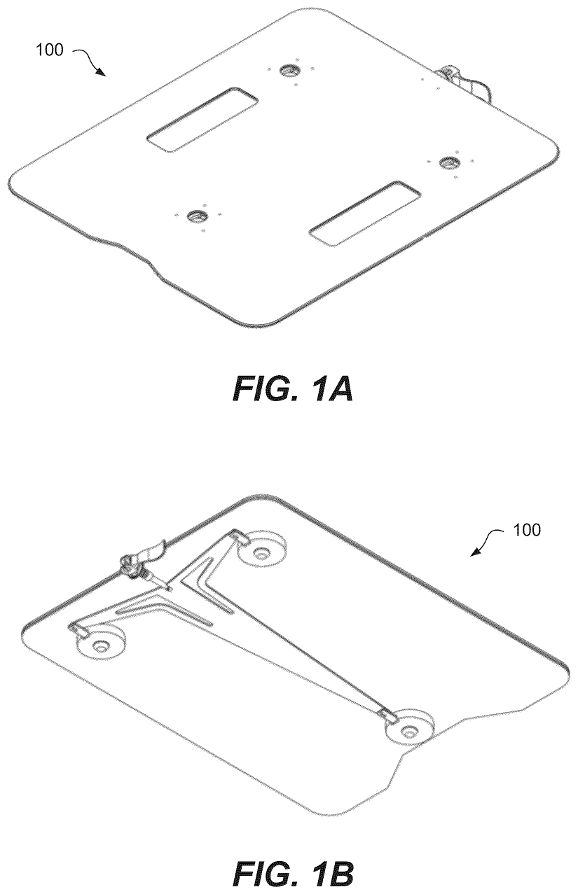

Embodiments are described below, by way of example only, with reference to FIGS. 1A-10.

FIGS. 1A and 1B show top and bottom perspective views respectively of a docking unit 100 of the attachment system in accordance with the present disclosure. The docking unit 100 is configured to be coupled to a mobile robot, and is configured to interface with a coupling unit of an attachment to be installed on the mobile robot. Together, the docking unit 100 and the coupling unit provide a universal attachment system, where the docking unit is configured to be coupled to a mobile robot, the coupling unit is configured to be coupled to an attachment, and the docking unit and coupling unit interface with one another to install the attachment onto the mobile robot.

It will be appreciated that while FIGS. 1A and 1B show an overall layout and design of an exemplary docking unit 100, alternative designs/layouts may be possible and thus the specific design shown in FIGS. 1A and 1B is not limiting. Importantly, the docking unit should be configured to provide a standardized interface to be coupled to a mobile robot and to interface with a coupling unit of the attachment system. Further details of the docking unit 100 will be further described herein below.

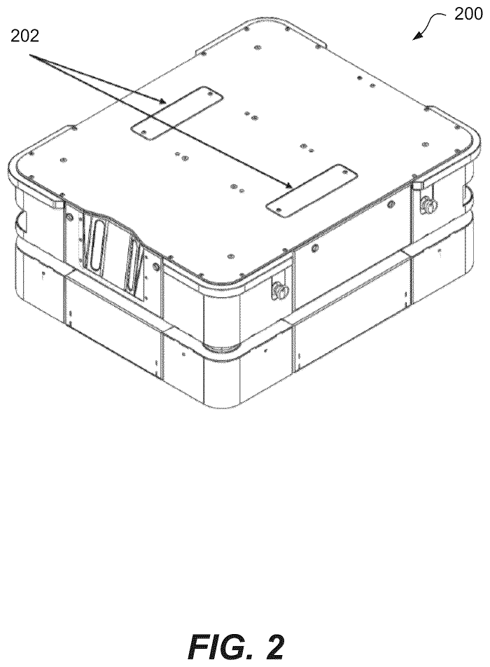

FIG. 2 shows a representation of a mobile base robot 200 that the attachment system may be used with. As described above, the attachment system may be used with collaborative mobile robots (CMRs) to improve the flexibility and efficiency of CMRs. As robots play an increasingly vital role across industries like manufacturing, logistics, and healthcare, there is a growing need for a universal, reliable method to switch between different attachments and modules. The attachment system disclosed herein addresses that need by providing a robust and versatile docking unit, such as the docking unit 100 shown in FIGS. 1A and 1B, that allows robots to easily switch between tasks, thereby minimizing downtime and maximizing productivity.

The mobile base robot 200 serves as the foundational platform of the attachment system. It is engineered with versatility to support various attachments, such as tools, sensors, and/or modules, making it adaptable to a wide range of operational environments and tasks. As shown in FIG. 2, the mobile base robot 200 comprises external attachment connection ports 202 for connecting to an attachment to be used with the mobile base robot 200.

As described in more detail herein below, the mobile base robot 200 incorporates the docking unit 100, which acts as the central hub for attaching and detaching attachments to the mobile base robot 200. The attachment system further comprises a coupling unit (described below) that is provided on an attachment and is configured to interface with the docking unit 100 in order to attach the attachment to the mobile base robot 200.

Together, the attachment system components enable a smooth and secure process for attaching and detaching task-specific modules, ensuring that robots can handle diverse tasks with stability and reliability. The universal design of the attachment system ensures compatibility with multiple tools and accessories, enabling the robot 200 to seamlessly switch between attachments and roles/functions without extensive reconfiguration.

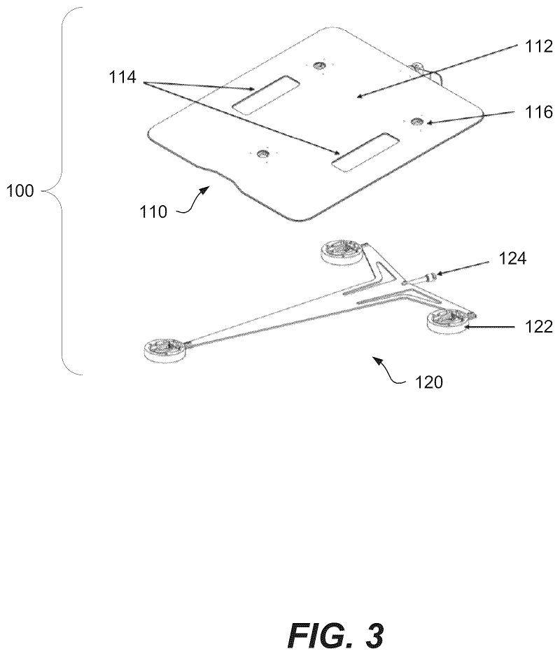

FIG. 3 shows an exploded perspective view of the docking unit 100 of the attachment system, comprising an attachment plate 110 and a locking mechanism 120. As described above, the docking unit 100 is the core hub of the attachment system, and it is meticulously designed to accommodate a wide variety of attachments, making it versatile for different operational environments and tasks.

The attachment plate 110 is responsible for interfacing with a coupling unit of an attachment to be connected to the mobile robot. The attachment plate 110 has a surface 112 that acts as the docking interface. The surface is engineered with precision, making it compatible with a wide range of attachments, from toolkits to robotic arms, cargo trays, etc. The attachment plate 110 includes external attachment connection port area(s) 114 on the surface 112, which are aligned with the external attachment connection ports 202 of the mobile base robot 200 as shown in FIG. 2. Further, the attachment plate 110 comprises one or more precisely-aligned retention slots 116 to receive a corresponding locking pin of the coupling unit. The retention slots 116 help to ensure a reliable connection, preventing misalignment and ensuring that the attachment process is smooth, even under pressure.

The locking mechanism 120 is coupled to the attachment plate 110 when assembled and is configured to lock the locking pin(s) of the coupling unit to ensure that once an attachment is docked, it remains securely fastened, minimizing the risk of failure during operation. The locking mechanism 120 comprises one or more locking units 122, each of the which is configured to receive and engage with a corresponding locking pin of the coupling unit. The locking units 122 are respectively arranged beneath the one or more retention slots 116 of the attachment plate 110.

As described in more detail herein below, the locking units 122 may comprise spring-loaded locking arms that engage automatically when an attachment and associated coupling unit interface with the docking unit 100 and a corresponding locking pin is inserted therein. These locking arms ensure that the attachment remains securely in place throughout the robot's operation. Compression springs add an extra layer of security, maintaining constant pressure on the locking arms to prevent detachment, even in dynamic environments. The locking mechanism 120 may also comprise a release lever 124 that is configured to be manually actuated to manually disengage the locking units 122, in particular the locking arms, to release the attachment. The release lever 124 is useful for manual disengagement when it's time to remove the attachment from the robot, as described in more detail below.

As shown and described herein below, the coupling unit is integrated/coupled with each attachment and interfaces seamlessly with the docking unit 100, providing a secure and reliable connection. Locking pins on the coupling unit are designed to be inserted through the retention slots 116 of the attachment plate 110, and to directly interface with the locking units 122 of the locking mechanism 120. The locking pins are crafted for durability and precision, ensuring that the connection remains stable even when the robot is subjected to rigorous tasks. By providing a strong and reliable attachment point, the locking pins ensure that the robot can handle both heavy loads and delicate tasks with equal effectiveness.

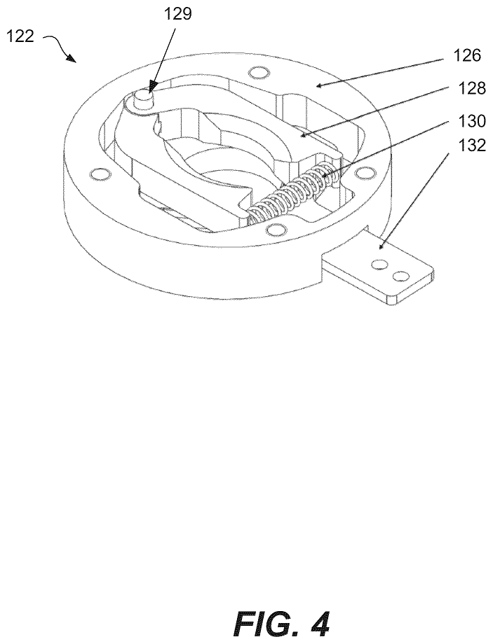

FIG. 4 shows an enlarged view of a locking unit 122 of the locking mechanism. The locking unit comprises a body 126, a pair of locking arms 128, a locking spring 130, and a slider 132.

The pair of locking arms 128 are pivotably coupled about a pivot point 129 at first ends thereof, and are coupled via the locking spring 130 at second ends thereof. The pair of locking arms 128 of the locking unit 120 and a corresponding locking pin of a coupling unit are sized so that the locking arms 128 are forced to pivot radially outwards as the locking pin is inserted therein, and the locking pin is shaped so that once inserted in the locking unit 122, the pair of locking arms 128 are pivoted radially inward to clamp against the locking pin under force of the locking spring 130. That is, the locking arms 128 are spring-loaded and open slightly due to the locking pin when the attachment is being inserted, and once the locking pin from the coupling unit is in place, the locking arms 128 snap back into position, locking the attachment securely.

The slider 132 helps guide the locking arms 128 and thus facilitates locking the locking pins into place between the corresponding locking arms 128, ensuring a smooth and precise docking process of the coupling unit to the docking unit. The slider 132 also plays a key role in ensuring the locking unit 120 engages automatically without requiring manual adjustment.

The operational mechanism for coupling an attachment to a mobile robot using the attachment system is now described. When an attachment module needs to be added, it is positioned at the top of the mobile robot, aligning the coupling unit of the attachment with the docking unit of the attachment system. The system is designed to make alignment simple and intuitive, allowing operators to quickly prepare the robot for its next task.

After alignment, the attachment is gently inserted, allowing the locking pins from the coupling unit to slide smoothly into the retention slots and the locking units of the docking unit. The spring-loaded locking arms automatically engage, securing the locking pins and thus the attachment module in place. This process ensures a stable, locked connection that can handle a variety of tasks without the risk of detachment. The attachment process is designed to be both fast and reliable, ensuring minimal downtime between task changes.

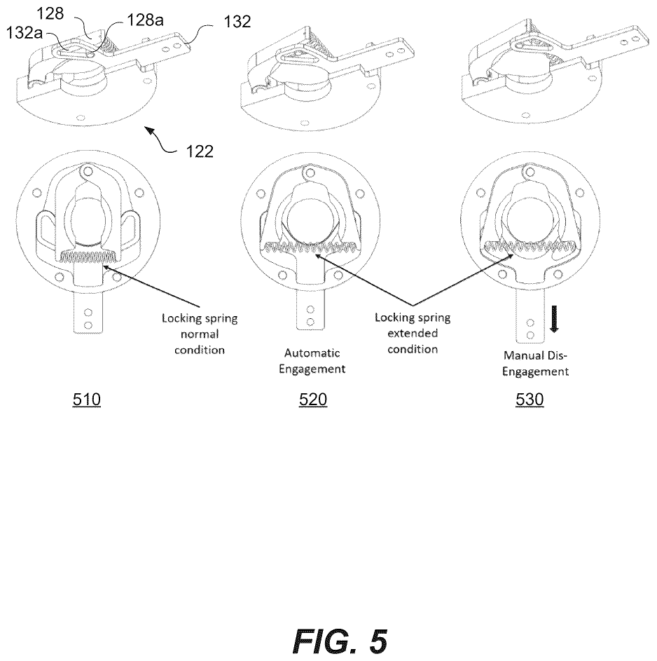

FIG. 5 shows perspective and top views of the locking unit operation. In particular, FIG. 5 shows the perspective and top views of the locking unit 122 in a normal condition (510), the locking unit 122 under automatic engagement (520), and the locking unit 122 when being manually disengaged (530). As can be seen in FIG. 5, each locking arm 128 comprises a locking arm pin 128a at a second end of the locking arm (i.e. the end proximal to the locking spring), and the slider 132 comprises a corresponding groove 132a that retains the locking arm pin 128a and guides the motion of the locking arm 128. The groove 132a is shaped so that the pair of locking arms pivot radially outwardly when the slider is actuated away from the locking unit.

During automatic engagement (520), as the attachment module is fully inserted, the spring-loaded locking arms of the locking unit automatically engage with the locking pins on the coupling unit. This automatic engagement facilitates a secure fit without the need for manual intervention, ensuring that the module is securely locked in place. The slider 132 ensures smooth and reliable engagement of the locking arms 128. As the locking pin is inserted into the locking unit, the locking pin presses against the locking arms 128, causing the locking arms 128 to open slightly (e.g. up to 15 degrees) and then snap back into place once the pins are fully inserted. This ensures that the attachment is locked securely, even in high-stress environments. The locking unit's design ensures that once locked, the module remains secure, providing stability and reliability throughout the robot's operation.

For manual disengagement (530), when the slider 132 is actuated away from the locking unit 120 as shown by the arrow, the groove 132a in the slider 132 is shaped and causes the locking arms 128 to open up again and pivot radially outwardly as the locking arm pin 128a slides along the edge of the groove 132a from a first end of the groove to a second end of the groove that is radially outward from the first end, releasing the locking pin from the locking arms and allowing the attachment to be safely removed. Actuation of the slider 132 away from the locking unit 120 can be achieved using the release lever of the locking mechanism, as described in more detail below.

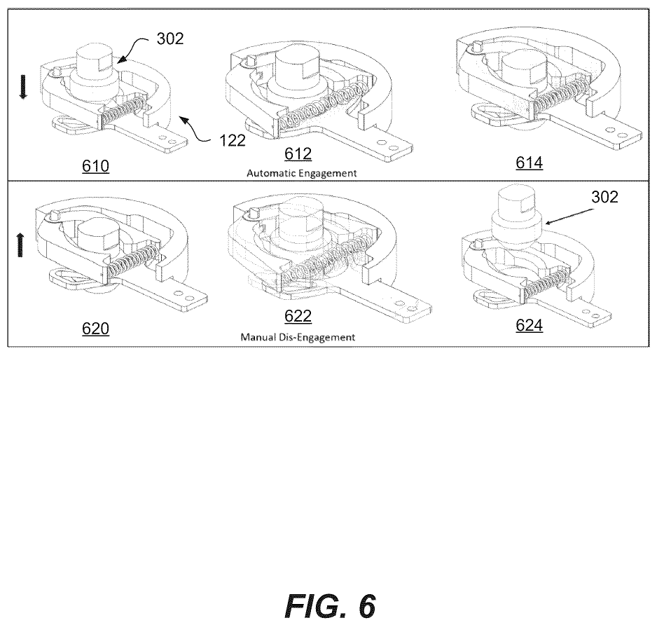

FIG. 6 shows representations of the locking unit during engagement and disengagement. More particularly, FIG. 6 provides a step-by-step depiction of the automatic engagement and manual disengagement process of the locking units. This is particularly useful for understanding the dynamics of how the attachment system functions in real time. The locking pin 302 of a coupling unit can also be clearly seen interacting with the locking unit 122.

Views 610, 612, and 614 depict the automatic engagement of the locking pin 302 by the locking unit 122. View 610 shows the locking pin 302 approaching the locking arms. This is the moment just before the locking unit locks the locking pin 302 into place. View 612 depicts the automatic engagement, where the locking arms open as the locking pin is inserted further. View 614 demonstrates how the locking spring forces the locking arms back into their locked position once the locking pin is fully inserted. As described previously, the pair of locking arms and the locking pin are sized so that the locking arms are pivoted radially outwards as the locking pin is inserted therein, and the locking pin is shaped so that once inserted in the locking unit, the pair of locking arms are pivoted radially inward to clamp against the locking pin under force of the locking spring. These views highlight the simplicity and efficiency of the automatic locking process.

Views 620, 622, and 624 depict the manual disengagement of the locking pin 302 from the locking unit 122. The detachment process is designed to be as simple and efficient as the attachment process, allowing for quick removal of attachments when they are no longer needed. As described above, the locking mechanism may include a release lever 124 (see FIG. 3) that simplifies the detachment process. When the release lever is pulled, it triggers the retraction of the slider 132, which causes the locking arms to open (via the shape of the groove 132a in the slider), extending the locking spring, and release the locking pins. This manual disengagement allows operators to remove the attachment quickly and efficiently, without the need for additional tools or complex procedures. View 620 displays the locking pin 302 in its fully locked position, i.e. when it is securely attached to the robot. View 622 shows how the internal slider mechanism works when the release lever is activated, extending the locking arms and allowing the locking pin and corresponding attachment to be removed. View 624 demonstrates the final step of the disengagement process, where the locking pin is removed and the locking arms and spring return to their initial positions, ready for the next attachment.

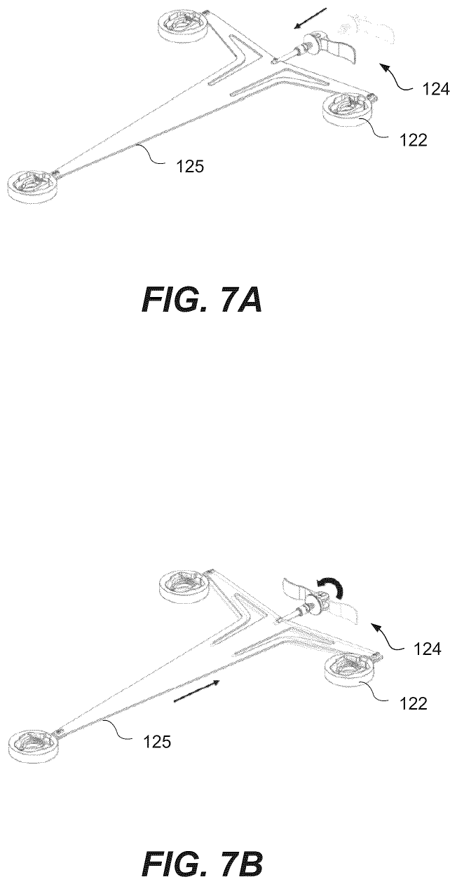

FIGS. 7A and 7B show representations of a release lever mechanism of the locking mechanism 120. As described above, the slider 132 of each of the locking units 122 is coupled to the second ends of the pair of locking arms, and is configured to cause the pair of locking arms to pivot when actuated. As shown in FIGS. 7A and 7B, the locking mechanism 120 comprises a locking plate 125, which is coupled to the slider of the one or more locking units 122. The release lever 124 is coupled to the locking plate 125 and is configured to be manually actuated. Accordingly, actuation of the release lever 124 is configured to cause a corresponding movement of the locking plate 125 and hence the slider of the one or more locking units 122. The release lever 124 can thus be used to manually disengage the locking arms of the locking units, as described above, and helps make the detachment process as smooth and quick as possible.

FIG. 7A shows the release lever 124 being inserted into the locking plate 125. This view demonstrates how the release lever 124 connects with the locking plate 125, which is coupled with the locking arms via the sliders of the respective locking units 122 as previously described.

FIG. 7B depicts the rotation of the lever by 180 degrees, which allows the locking plate 125 to be pulled outwards in a first direction and simultaneously unlocks all the locking units 122 via the slider. This simple movement allows the attachment to be easily removed, making it possible to quickly swap out modules without requiring complex tools or additional effort.

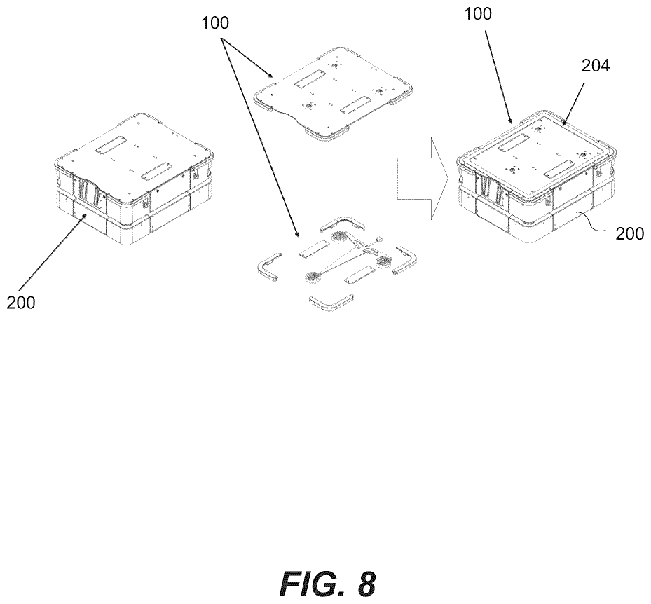

FIG. 8 shows a representation of the attachment system integrated with the mobile base robot. In particular, FIG. 8 shows the mobile base robot 200 (e.g. a CMR) and the docking unit 100 comprising the attachment plate and locking mechanism to be integrated with the mobile robot 200. As described above, the attachment plate of the docking unit 100 has one or more attachment ports for respectively interfacing with a corresponding attachment connection of the attachment, and these align with the attachment ports of the mobile robot 200 (see FIG. 2), ensuring compatibility with existing attachment/locking mechanisms. The final integration of the docking unit 100 with the mobile robot 200 is shown, and cushion pads 204 may be added to provide extra stability and reduce vibration, ensuring a smooth and stable attachment even in high-movement environments

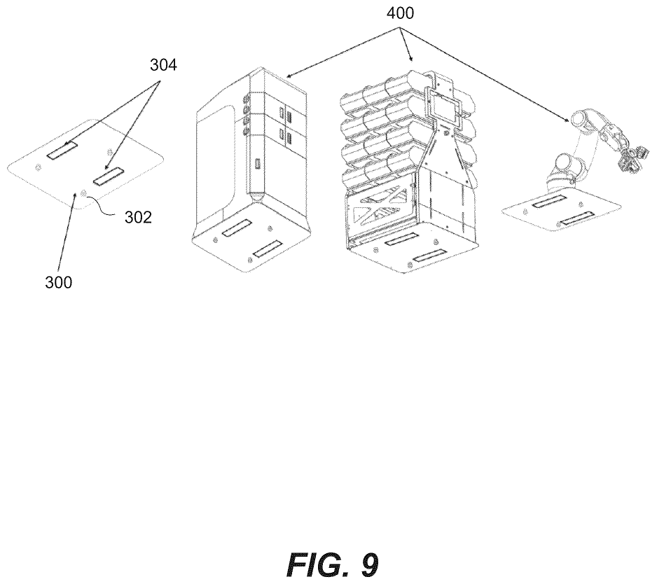

FIG. 9 shows representations of a coupling unit 300 integrated with various attachments 400. A stand-alone coupling unit 300 is also depicted, with locking pins 302 and an external attachment connection area 304 with which the attachment connections from the attachments 400 interface, to provide a standardized interface designed for easy connection and disconnection, as described above. The coupling unit 300 serves as the base for integrating a variety of attachments, such as attachments 400, promoting rapid reconfiguration for different tasks.

The coupling unit 300 is shown as being integrated with various attachments 400, including a cabinet attachment (e.g. demonstrating how the mobile robot can be configured with the attachments to carry large, enclosed modules, ideal for transporting or storing materials securely in industrial settings), a tray-type attachment (e.g. ideal for holding and transporting multiple items simultaneously), and a robotic arm attachment (e.g. highlighting the docking unit's adaptability for precise and complex tasks such as assembly or manipulation). The attachments 400 enable the mobile robot to perform technical operations beyond simple material transport, enhancing its operational versatility.

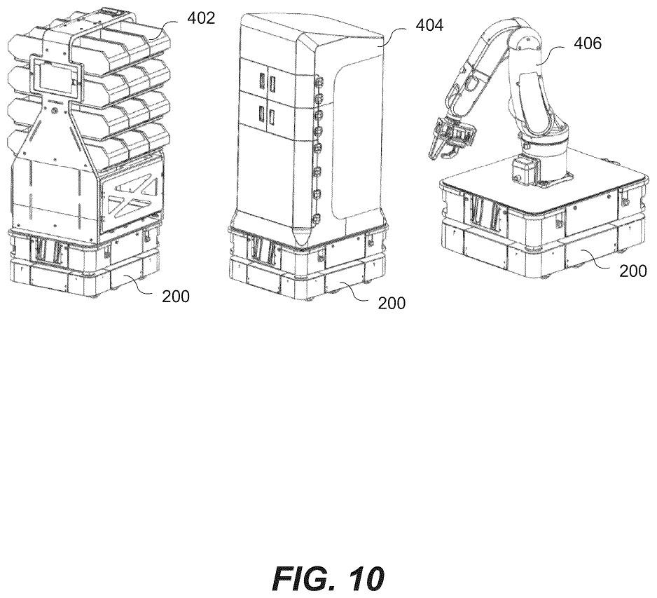

FIG. 10 shows representations of various attachments coupled with the mobile base robot 200 using the attachment system. FIG. 10 provides real-world examples of how the attachment system can be used to connect attachments to the base robot 200 in different operational settings. The modularity and adaptability of the attachment system allows for integrating different attachments with the mobile base robot 200, making the robot suitable for a wide range of applications, from storage and transport to intricate tasks requiring robotic precision, etc. The different views shown in FIG. 10 are described below.

View 1 (left-hand side of FIG. 10): Features a tray-type attachment 402, ideal for holding and transporting multiple items simultaneously. This configuration is particularly suited for applications requiring open access to stored components or tools, making it efficient for handling and assembly tasks.

View 2 (middle of FIG. 10): Displays a cabinet attachment 404, designed for secure and enclosed transport or storage of materials. This setup is commonly used in environments where safety or security is a concern, ensuring that sensitive or valuable items are protected during transit.

View 3 (right-hand side of FIG. 10): Shows the robotic arm attachment 406, which allows the CMR to perform more intricate tasks, such as assembly, manipulation, or precise operations. This attachment highlights the system's flexibility in switching from material handling to technical, high-precision tasks that require the dexterity of a robotic arm.

Together, these views demonstrate the wide range of capabilities offered by the attachment system, enabling the CMR/mobile base robot 200 to switch between different functional roles seamlessly. This modular approach enhances the mobile base robot's versatility, making it applicable to various industries, from manufacturing to logistics and beyond.

A method of configuring a mobile robot thus comprises installing a docking unit of the attachment system onto the mobile robot, installing the coupling unit of the attachment system onto the attachment, and installing the coupling unit with the attachment onto the docking unit of the mobile robot, where the one or more locking pins of the coupling unit are inserted into the one or more locking units of the docking unit. The attachment installed on the mobile robot can be easily changed by removing the attachment from the mobile robot by disengaging the coupling unit from the docking unit, and installing a new attachment onto the mobile robot by installing the new attachment with a coupling unit thereon to the docking unit installed on the mobile robot.

It will thus be readily appreciated from the foregoing description that the attachment system disclosed herein offers many significant advantages, including but not limited to:
Enhanced Flexibility: Facilitates quick reconfiguration of CMRs/AMRs to suit various operational tasks and environmental conditions.
Operational Efficiency: Reduces downtime associated with attachment changes, thereby optimizing overall productivity.
Reliability and Safety: Ensures secure attachment and stable operation through robust locking mechanisms, promoting operational reliability and workplace safety.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. An attachment system for a mobile robot, comprising:
a docking unit configured to be coupled to the mobile robot and to interface with a coupling unit of an attachment to be installed on the mobile robot, the docking unit comprising:
an attachment plate comprising one or more attachment ports for respectively interfacing with a corresponding attachment connection of the attachment; and
a locking mechanism coupled to the attachment plate and comprising one or more locking units, wherein each of the one or more locking units is configured to receive and engage with a corresponding locking pin of the coupling unit.

2. The attachment system of claim 1, wherein the attachment plate comprises one or more retention slots each configured to receive the corresponding locking pin of the coupling unit, and wherein the one or more locking units are respectively arranged beneath the one or more retention slots.

3. The attachment system of claim 1, wherein each of the one or more locking units comprise a pair of locking arms pivotably coupled at first ends thereof, and coupled via a locking spring at second ends thereof.

4. The attachment system of claim 3, wherein the pair of locking arms and the locking pin are sized so that the locking arms are pivoted radially outwards as the locking pin is inserted therein, and the locking pin is shaped so that once inserted in the locking unit, the pair of locking arms are pivoted radially inward to clamp against the locking pin under force of the locking spring.

5. The attachment system of claim 4, wherein each locking unit further comprises a slider coupled to the second ends of the pair of locking arms, wherein the slider is configured to cause the pair of locking arms to pivot when actuated.

6. The attachment system of claim 5, wherein each locking arm comprises a locking arm pin at the second ends thereof, and wherein the slider comprises a pair of grooves respectively retaining a corresponding locking arm pin.

7. The attachment system of claim 6, wherein the pair of grooves are shaped to cause the pair of locking arms to pivot radially outwardly when the slider is actuated away from the locking unit.

8. The attachment system of claim 5, wherein the locking mechanism further comprises:
a locking plate coupled to the slider of the one or more locking units; and
a release lever coupled to the locking plate and configured to be manually actuated,
wherein actuation of the release lever is configured to cause a corresponding movement of the locking plate and the slider of the one or more locking units to disengage the locking arms.

9. The attachment system of claim 1, further comprising the coupling unit configured to be installed on the attachment.

10. The attachment system of claim 1, wherein the attachment is a tool, a sensor, or a module.

11. A mobile robot, comprising:
an attachment system, comprising:
a docking unit configured to interface with a coupling unit of an attachment to be installed on the mobile robot, the docking unit comprising:
an attachment plate comprising one or more attachment ports for respectively interfacing with a corresponding attachment connection of the attachment; and
a locking mechanism coupled to the attachment plate and comprising one or more locking units, wherein each of the one or more locking units is configured to receive and engage with a corresponding locking pin of the coupling unit.

12. The mobile robot of claim 11, wherein the attachment is installed on the mobile robot, and wherein the attachment system further comprises the coupling unit coupled to the attachment, the coupling unit is coupled to the docking unit, and the coupling unit comprising one or more locking pins inserted into corresponding of the one or more locking units of the docking unit.

13. The mobile robot of claim 12, wherein the attachment is a tool, a sensor, or a module.

14. The mobile robot of claim 11, wherein the attachment plate comprises one or more retention slots each configured to receive the corresponding locking pin of the coupling unit, and wherein the one or more locking units are respectively arranged beneath the one or more retention slots.

15. The mobile robot of claim 11, wherein each of the one or more locking units comprise a pair of locking arms pivotably coupled at first ends thereof, and coupled via a locking spring at second ends thereof.

16. The mobile robot of claim 15, wherein the pair of locking arms and the locking pin are sized so that the locking arms are pivoted radially outwards as the locking pin is inserted therein, and the locking pin is shaped so that once inserted in the locking unit, the pair of locking arms are pivoted radially inward to clamp against the locking pin under force of the locking spring.

17. The mobile robot of claim 16, wherein each locking unit further comprises a slider coupled to the second ends of the pair of locking arms, wherein the slider is configured to cause the pair of locking arms to pivot when actuated.

18. The mobile robot of claim 17, wherein each locking arm comprises a locking arm pin at the second ends thereof, and wherein the slider comprises a pair of grooves respectively retaining a corresponding locking arm pin.

19. A method of configuring a mobile robot, comprising:
installing a docking unit of an attachment system onto the mobile robot, the docking unit comprising:
an attachment plate comprising one or more attachment ports for respectively interfacing with a corresponding attachment connection of an attachment to be installed on the mobile robot; and
a locking mechanism coupled to the attachment plate and comprising one or more locking units, wherein each of the one or more locking units is configured to receive and engage with a corresponding locking pin of the coupling unit;
installing a coupling unit of the attachment system onto the attachment, the coupling unit comprising one or more locking pins for insertion into corresponding of the one or more locking units of the docking unit; and
installing the coupling unit with the attachment onto the docking unit of the mobile robot, wherein the one or more locking pins of the coupling unit are inserted into the one or more locking units of the docking unit.

20. The method of claim 19, further comprising changing the attachment by:
removing the attachment from the mobile robot by disengaging the coupling unit from the docking unit; and
installing a new attachment onto the mobile robot by installing the new attachment with a coupling unit thereon to the docking unit installed on the mobile robot.
